(19) United States
(12) Patent Application Publication
(10) Pub. No.: US 2013/0218799 A1
(43) Pub. Date: Aug. 22, 2013

(54) Container Selection in a Materials Handling Facility

(71) Applicants: Sebastian Lehmann, Seattle, WA (US); Subramanian Sundaresan, Seattle, WA (US); Hardik B. Doshi, Seattle, WA (US)

(72) Inventors: Sebastian Lehmann, Seattle, WA (US); Subramanian Sundaresan, Seattle, WA (US); Hardik B. Doshi, Seattle, WA (US)

(21) Appl. No.: 13/398,602

(22) Filed: Feb. 16, 2012

(51) Int. Cl. G06Q 50/28

(52) U.S. Cl. 705/337

(57) ABSTRACT

Described herein are systems and techniques for recommending custom containers in a materials handling facility dependent on physical characteristics of an item or group of items to be shipped and/or dependent upon estimated shipping costs. For example, the systems described herein may determine dimensions for forming a custom container within the materials handling facility that is capable of containing an item or group of items for shipment. The total cost to ship the item or group of items in the custom container or a standard container can also be determined and the container with the lowest total cost may be recommended for use in packaging the item or group of items for shipment.

### BACKGROUND

Many companies package items and/or groups of items together for a variety of purposes, such as e-commerce and mail-order companies that package items (e.g., books, CDs, apparel, food, etc.) to be shipped to fulfill orders from customers. Retailers, wholesalers, and other product distributors (which may collectively be referred to as distributors) typically maintain an inventory of various items that may be ordered by clients or customers. This inventory may be maintained and processed at a materials handling facility which may include, but is not limited to, one or more of: warehouses, distribution centers, cross-docking facilities, order fulfillment facilities, packaging facilities, shipping facilities, or other facilities or combinations of facilities for performing one or more functions of material (inventory) handling.

A common concern with fulfilling items and/or groups of items, referred to herein as “item packages,” involves ensuring that appropriate containers are used for shipping them, both to minimize costs and to protect the item contents. An agent may select from a limited number of available standard dimension containers, referred to herein as “standard containers,” based on a visual assessment of the item or items once they are picked from inventory and/or grouped. This visual method of selecting containers may be prone to human error, as an agent may select a container that is too small, larger than needed to handle the item or items, or that does not adequately protect the contents of the container. This may result in higher costs associated with using an inappropriate container or result in additional costs associated with re-work—in the case that an agent must re-package the item(s) or use multiple containers. Still further, even when the agent does visually select the correct container from the available standard containers, due to the limited number of standard containers typically available in a materials handling facility, the container may still be larger than necessary for fulfilling the item or group of items. Transporting an item or a group of items in a container that is larger than necessary may result in a higher fulfillment cost than transporting the same item(s) in a smaller container, due to the cost of the container and/or any higher fees associated with transporting a larger or heavier container. Similarly, transporting an item or items in a container that is larger than necessary, or not filling each container to capacity, may waste valuable (and expensive) transportation space (e.g., space in a truck or in a shipping container that will be placed on a train or an airplane). These excess costs associated with transporting items packaged in inappropriate containers may significantly reduce profit margins in some materials handling facilities.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 illustrates a broad view of the operation of a materials handling facility, in one embodiment.

FIGS. 2A-2C illustrate a transition diagram of one embodiment of a system configured for recommending containers for handling one or more items based on both physical characteristics of the items and costs for fulfilling the items.

FIG. 3A is a block diagram of standard container containing items.

FIG. 3B is a block diagram of a custom container containing items.

FIG. 4 is a flow diagram illustrating an example process for selecting a standard container or custom container for use in fulfilling items.

FIG. 5 is a flow diagram illustrating a process for recommending a standard container and a custom container, according to one embodiment.

FIG. 6 is a flow diagram illustrating one embodiment of a process for picking, sorting, packing and shipping an item.

FIG. 7 is a flow diagram illustrating one embodiment of a method for utilizing a container recommendation service in a packaging information system.

FIG. 8 is a flow diagram illustrating one embodiment of a process for collecting feedback on the usage of recommended containers.

FIG. 9 is a block diagram illustrating an example computer system configured to implement one or more of the packaging related operations described herein, according to one embodiment.

While embodiments are described herein by way of example for several embodiments and illustrative drawings, those skilled in the art will recognize that the embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

A packaging information system configured to facilitate stowing, picking, packing and/or shipping operations may include various components used to facilitate efficient and/or cost-effective operations in a materials handling facility. For example, in various embodiments, a packaging information system may include an inventory management system, a planning service, a product dimension estimator, a product dimension correction manager, a container recommendation service, one or more custom container forming devices, a package performance analyzer, and/or a packaging service which may be utilized together or separately to facilitate efficient and/or cost-effective operations in the materials handling facility. For example, one or more of these components may be utilized to recommend a standard container or a custom container that is suitable for shipping one or more items from the materials handling facility dependent on physical characteristics of the one or more items, such as physical dimension values, and estimated fulfillment costs for the item or group of items. A “custom container,” as used herein, is any container that is formed within a materials handling facility according to physical characteristics (e.g., length, width, height) associated with one or more items to be placed in the container. For example, the physical characteristics may be dimension values (e.g., length, width, height) associated with an item that is to be placed in the custom container for shipping and the container may be formed based on those provided dimension values, referred to herein as “custom container dimension values” In some examples, a custom container may be formed using an EM6 or EM7-25 packaging machine available from Packsize® International LLC, a Box on Demand™ packaging machine, or manually formed by cutting a custom container from one or more blanks of corrugate, in response to receiving custom container dimension values from the container recommendation service as part of a shipping operation for shipping one or more items.

In some embodiments, a custom container may be selected to reduce the transportation costs associated with shipping an item or group of items to a customer. For example, if a customer orders an item that is to be shipped to their home address in Seattle, Wash. from a materials handling facility located in Lexington, Va., the packaging information system may identify and recommend a standard container available at that materials handling facility within which the item may be shipped to the customer and also determine custom container dimension values for a custom container that can be formed in that materials handling facility and used to ship the item to the customer. For each (standard container and custom container) a total shipment cost can be estimated that includes, for example, transportation costs, labor costs and packaging materials costs. Typically, transportation costs are the largest factor in fulfillment and often vary based on the overall volume of the container; larger volume containers generally costing more to ship than lower volume containers. In addition to transportation costs, other costs may vary between a standard container and a custom container. For example, there may be an additional cost applied to a custom container due to a higher cost of the corrugate, the cost of utilizing the machine, the depreciation cost of the machine itself, or the additional labor necessary to operate the machine.

By estimating the total shipment cost for each of a recommended standard container and a custom container, the packaging information system can determine the lowest total cost combination to deliver the item to the customer. Continuing with the above example, if the item to be shipped has dimensions of 12 in.×10 in.×2.5 in., the packaging information system may select a standard container available at the materials handling facility that has dimensions of 15 in.×12.5 in.×3 in.—representing the smallest available standard container in the materials handling facility in Lexington that is still large enough to handle the item to be shipped. In addition, the packaging information system may determine that a custom container having custom container dimensions of 12.2 in.×10.2 in.×2.7 in. can be formed using a custom container forming device in the materials handling facility for use in shipping the item to the customer.

Based on those two options, the system may determine that the transportation cost for the standard container, referred to herein as standard container transportation cost, is $7.50 and the transportation cost for the custom container, referred to herein as custom container transportation cost, is $6.25. Provided that the other costs (e.g., overhead, materials, machine) associated with utilizing the custom container do not exceed $1.25, the packaging information system may recommend that the item be shipped in the custom container and route the item to a packing station with a custom container forming device capable of forming a custom container having the recommended custom container dimension values. In this example, utilizing the custom container lowers the total fulfillment cost for the item, thereby increasing the overall profit margin of the materials handling facility.

In some embodiments, a container recommendation may also be dependent on the customer to whom the item is to be shipped, an applicable service level agreement, the destination of the item, the carrier selected for transporting the item, item affinity information, an indicator of the fragility of the item, the weight of the item, and/or an environmental constraint associated with the item (e.g., a restriction on the temperature and/or humidity at which the item should be held during transport). In addition, a container recommendation may also be based on ensuring a good customer experience. For example, a custom container may be selected, even if more costly, so that the item contained in the container fits well and the customer does not receive a container that is unnecessarily large, and filled with a large amount of dunnage.

As used herein, the term “item package” may refer to a single item to be shipped (or otherwise handled in a container) alone, or to multiple items that have been grouped together for shipping to a customer in a single container. The term “container” may refer to any dimensionally-constrained environment, such as crates, cases, bins, boxes, mailing envelopes or folders, or any other apparatus capable of handling one or more items for storing, conveying or transporting.

For illustrative purposes, some embodiments of a packaging information system (and/or various components thereof) are discussed below in which particular item and container parameters are analyzed in particular manners, and in which particular types of analyses and processing of parameters is performed. However, those skilled in the art will appreciate that the techniques described may be used in a wide variety of other situations, and that other embodiments are not limited to the details of these example embodiments.

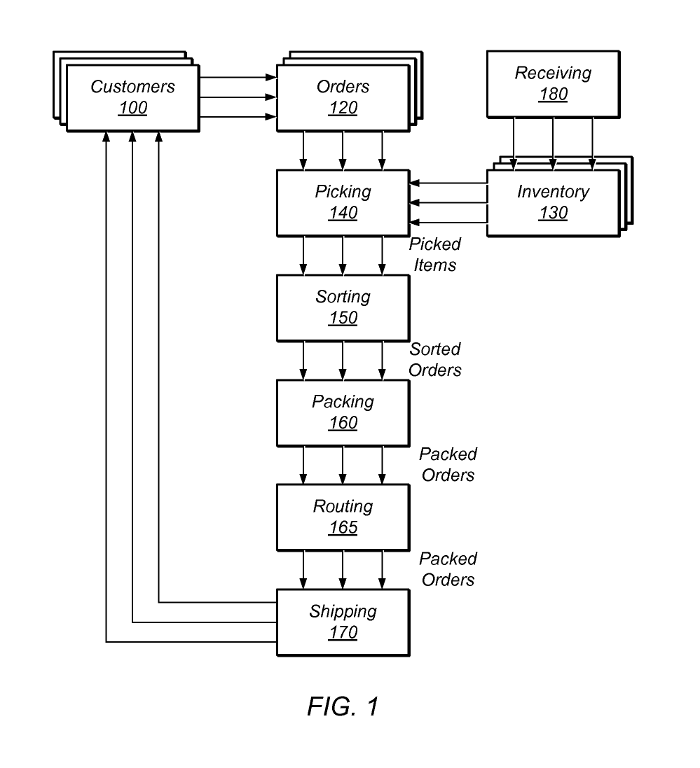

A block diagram of a materials handling facility, which, in one embodiment, may be an order fulfillment facility configured to utilize various systems and methods described herein, is illustrated in FIG. 1. In this example, multiple customers 100 may submit orders 120 to a distributor, where each order 120 specifies one or more items from inventory 130 to be shipped to the customer or to another entity specified in the order. An order fulfillment facility typically includes a receiving operation 180 for receiving shipments of stock from various vendors and storing the received stock in inventory 130. To fulfill the orders 120, the one or more items specified in each order may be retrieved or “picked” from inventory 130 (which may also be referred to as stock storage) in the order fulfillment facility, as indicated by block 140. In some embodiments, the items in an order may be divided into multiple item packages (i.e., shipment sets) for fulfillment by a planning service before item package fulfillment instructions are generated (not shown).

In this example, picked items may be delivered to one or more stations in the order fulfillment facility for sorting 150 into their respective orders or shipment sets and for packing. A package routing operation 165 may sort packed orders for routing to one of two or more shipping operations 170, from which they may be shipped to the customers 100. The package routing operation 165 may in various embodiments be automated or manual. The package routing operation 165 may receive an indication of the destination to which each packed order should be routed from a central control system. In some embodiments, a predictive router may determine a routing destination for each packed order dependent on the size of a container that is recommended for shipping the order and/or whether the container to be used in transporting the order is a standard container or a custom container.

The predictive router may provide an indication of the predictive routing destination to the central control system, and/or directly to the package routing operation 165, so that the packed order may be diverted to an appropriate shipping operation 170, as described herein. In other embodiments, a routing operation may route picked or sorted items to a particular packing station 160, dependent on whether a standard container (e.g., a pre-formed box or mailer) or a custom container has been recommended for shipping the item or items. For example, if a custom container has been recommended for shipping, a routing operation may route picked or sorted items to a particular packing station 160 that includes a custom container forming device configured to form the container to match the recommended custom container dimension values. In other embodiments, when a standard container is selected, the routing operation may route the picked or sorted items to a particular packing station 160 dependent upon the size or type of the recommended standard container. For example, not all standard containers utilized in the facility may be available at all of the packing stations 160. Similarly, some packing stations 160 may not have access to protective materials recommended for shipping fragile items or items for which additional protection may be appropriate. Therefore, if an item (or at least one item in a group of items to be shipped together) requires special packaging, a routing operation may be configured to direct the item(s) to a packing station 160 at which an appropriate container and/or protective materials are available.

Note that not every fulfillment facility may include both sorting and packing stations. In certain embodiments, agents may transfer picked items directly to a packing station, such as packing station 160, while in other embodiments, agents may transfer picked items to a combination sorting and packing stations (not illustrated). This may result in a stream and/or batches of picked items for multiple incomplete or complete orders being delivered to a sorting station for sorting 150 into their respective orders for packing and shipping, according to one embodiment.

Note that portions of an order may be received at different times, so sorting 150 and packing may have to wait for one or more items for some orders to be delivered to the sorting station(s) before completion of processing the orders. Note that a picked, packed and shipped item package does not necessarily include all of the items ordered by the customer; a shipped item package may include only a subset of the ordered items available to ship at one time from one inventory storing location. Also note that the various operations of an order fulfillment facility may be located in one building or facility, or alternatively may be spread or subdivided across two or more buildings or facilities.

A container recommendation service (which may provide standard container recommendations, custom container recommendations and/or specialty packaging recommendations), as described herein in various embodiments, may be utilized in a number of different facilities and situations, including, but not limited to, materials handling facilities, order fulfillment centers, rental centers, retailers, distribution centers, packaging facilities, shipping facilities, libraries, museums, warehouse storage facilities, and the like. Note that the arrangement and order of operations illustrated by FIG. 1 is merely one example of many possible embodiments of the operation of an order fulfillment facility utilizing a container recommendation service. Other types of materials handling, manufacturing, or order fulfillment facilities may include different, fewer, or additional operations and resources, according to different embodiments.

The items in a materials handling facility may be of varying shapes, sizes, and weight. For example, some items in a materials handling facility may be irregularly shaped. To facilitate container recommendation and/or more efficient shipping, irregularly shaped items may be handled in boxes or other regularly shaped packaging, which may make stacking of such items possible. In other embodiments, irregularly shaped items may be handled without placing them in regularly shaped packaging. According to various embodiments, automated product dimension estimation and/or correction may be utilized with any regularly shaped or irregularly shaped items.

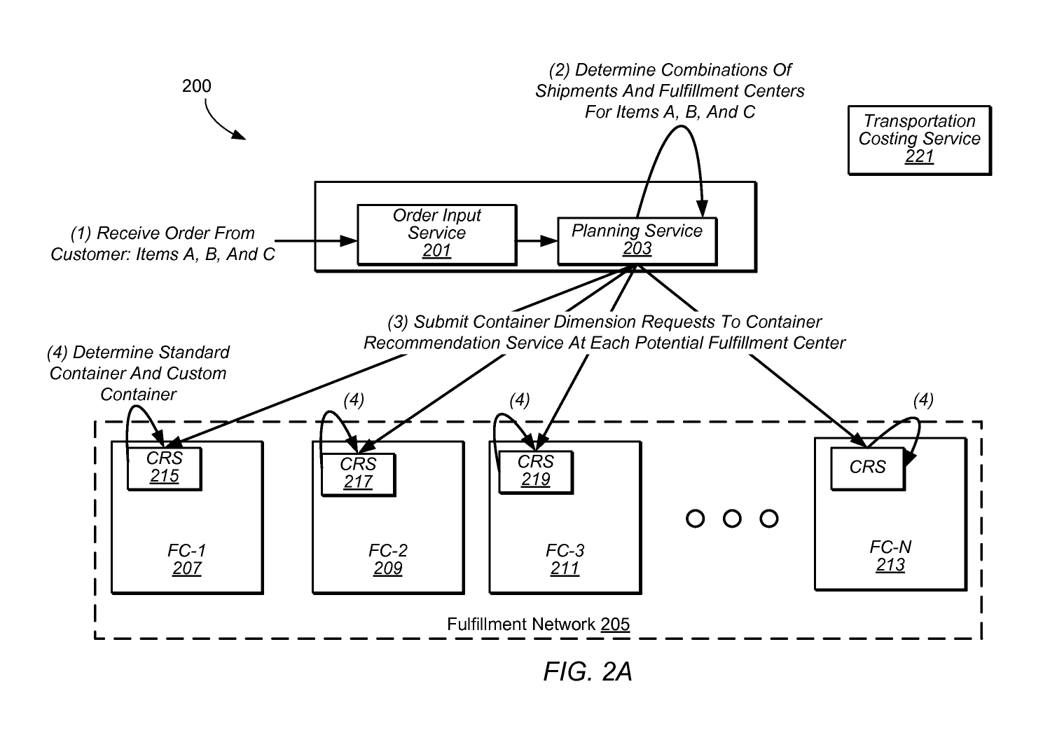

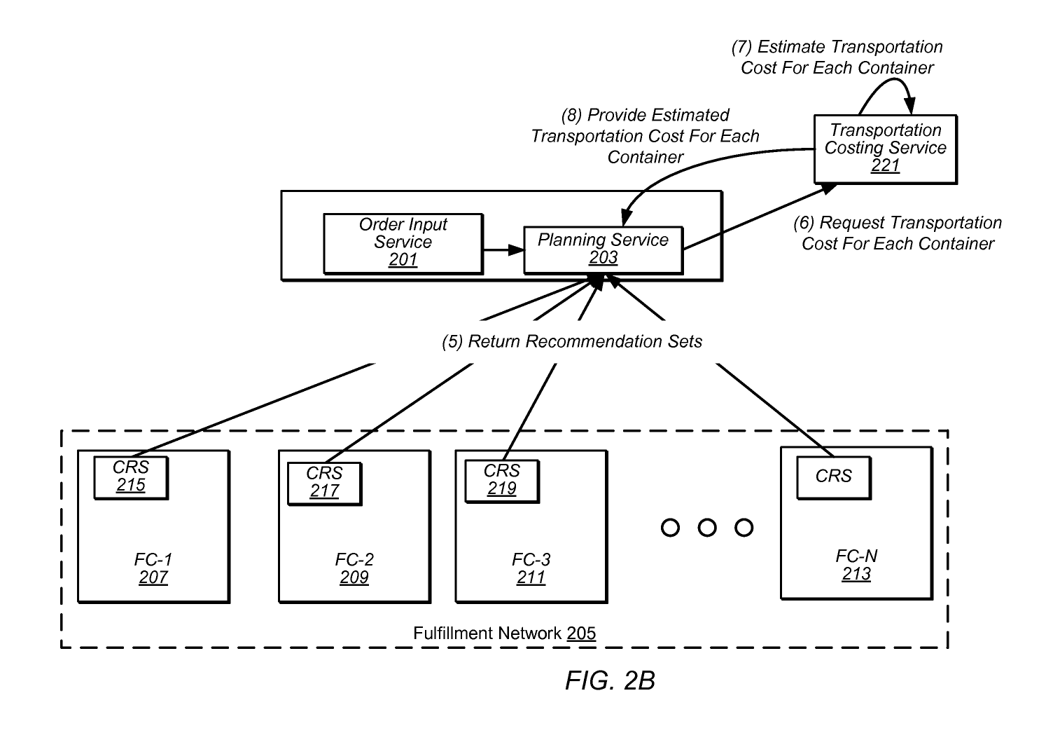

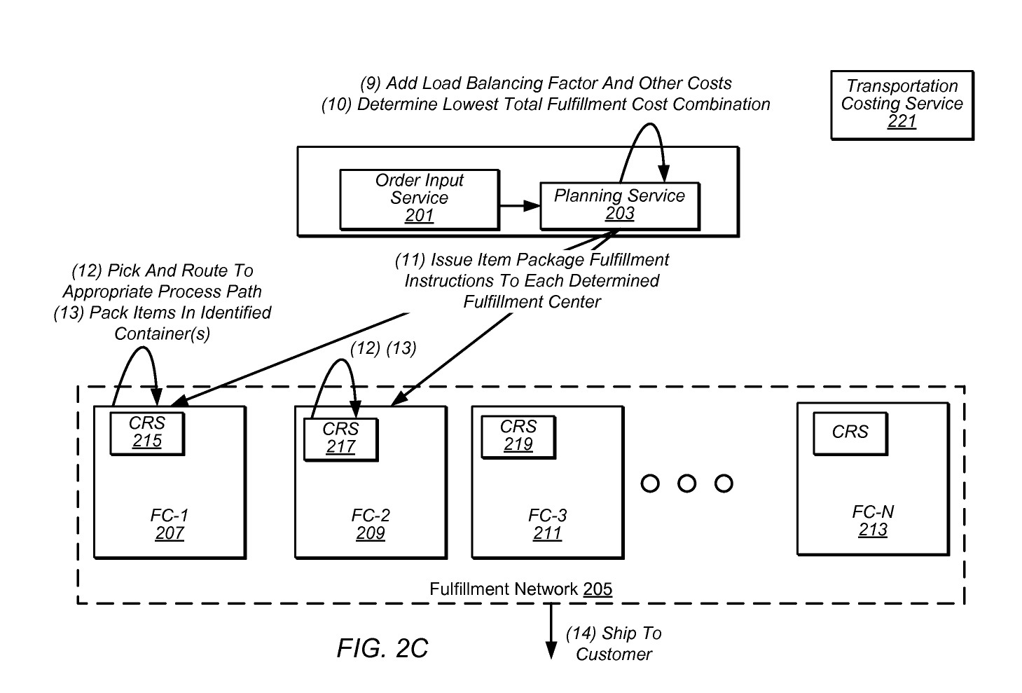

FIGS. 2A-2C is a state diagram illustrating one embodiment of a packaging information system 200 configured for recommending containers for handling an item package based on both physical characteristics of the item package and costs for shipping the item package. Starting with FIG. 2A, the packaging information system 200 begins by receiving an order for one or more items from a customer. In this example, a customer places an order for three items: A, B, and C. The order input service 201 receives the order and provides it to the planning service 203. The planning service 203 determines different combinations of the items that can be shipped from different fulfillment centers. For example, as shown in FIG. 2A, the fulfillment network 205 may include any number of fulfillment centers, such as FC-1 207, FC-2 209, FC-3 211, through FC-N 213. For each, the planning service 203 will determine the various combinations of the ordered items the fulfillment center is capable of shipping. Continuing with the above example, the planning service 203 may determine the FC-1 207 is capable of shipping all three of items A, B, and C, that FC-2 204 is only capable of shipping item B, and FC-3 211 can ship items A and C. Based on those determinations, the planning service will identify the different combinations of items (item packages) that can be fulfilled by each fulfillment center. In this example, the planning service would determine that FC-1 207 is capable of shipping the following item packages: {A}, {B}, {C}, {A, B}, {A, C}, {B, C}, {A, B, C}; FC-2 209 is capable of shipping the following item packages: {B} and that FC-3 211 is capable of shipping the following item packages: {A}, {C}, {A, C}. In an alternative embodiment, the planning service 203 may obtain the different combination of item packages from an inventor management service (not shown) that maintains inventory information for each fulfillment center within the fulfillment network 205.

Upon determining the different item packages that can be fulfilled by the various fulfillment centers, the planning service 203 submits requests to a container recommendation service at each fulfillment center, requesting container recommendations for each of the item packages the respective fulfillment center is capable of shipping. Referring to the above example, the planning service 203 will submit seven requests to container recommendation service 215 at FC-1 207, one request to container recommendation service 217 at FC-2 209, and three requests to container recommendation service 219 at FC-3 211. As discussed in more detail below, the respective container recommendation services 215, 217, 219 determine both the standard container for shipping each of the item packages and custom container dimension values for use in forming a custom container for shipping each of the item packages.

Turning now to FIG. 2B, once the container recommendation service has determined the standard container and custom container dimension values for each item package request, that information is returned to the planning service 203. For example, FC-1 207 returns seven recommendation sets, each recommendation set containing a standard container recommendation and recommended custom container dimension values, FC-2 209 returns one recommendation set, containing a standard container recommendation and recommended custom container dimension values, and FC-3 returns three recommendation sets, each recommendation set containing a standard container recommendation and recommended custom container dimension values. In the alternative, as discussed above, if the requests for standard container recommendation(s) and custom container recommendations are submitted to separate services—e.g., the request for a recommended standard container going to a container recommendation service at a fulfillment center and the request for the recommended custom container dimensions goes to a global container recommendation service—the recommendations may returned by those separate services.

Upon receiving the container recommendations, or the container recommendation set, the planning service 203 then determines the estimated standard container transportation cost for each of the returned recommended standard containers and the estimated custom container transportation cost for containers formed according to each of the returned recommended custom container dimension values. In one example, the estimated transportation costs are determined by providing the recommendations to a transportation costing service 221. The transportation costing service 221 may maintain transportation costs from various carriers that are determined based upon the volume and/or weight of the container to be shipped. Transportation costs may be provided by the carriers themselves or calculated based on past events with those carriers from respective fulfillment centers. Alternatively, the transportation costing service 221 may estimate transportation costs based on industry averages for transporting items of various volumes and/or weights. While the discussion here includes determining a lowest cost, in alternative embodiments other factors may also be considered when estimating transportation costs. For example, transportation cost may depend on the carrier selected to transport the item, when the last transportation vehicle will leave the fulfillment center, the number of other packages assigned for transportation with a particular carrier or on a particular transportation vehicle, and the like. Utilizing this information and volumetric information for each of the recommended containers, the transportation costing service 221 determines estimated transportation costs for each of the recommended containers. The estimated transportation costs are then provided from the transportation costing service 221 to the planning service 203.

In addition to determining the estimated transportation cost for each item package from each fulfillment center, the planning service 203 may add additional estimated costs to determine an estimated total fulfillment cost for each item package from the various fulfillment centers. For example, the planning service 203 may determine an estimated custom container total fulfillment cost by adding a load balancing factor to the estimated transportation cost for each item package that has a corresponding custom container recommended for shipping. The load balancing factor may be used to help balance load across different packing stations within the fulfillment center or fulfillment network 205 so that not all shipments are routed to the packing stations with custom container forming devices. As discussed in more detail below, the load balancing factor may vary depending on the load packing request currently experienced by the packing stations with custom container forming devices, based on anticipated loads, based on historical loads during that time of day, based on the historical number of item packages, custom container forming device capacity, labor capacity for operating the custom container forming device(s) and/or other factors. In addition to adding a load balancing factor, the planning service 203 may also add other costs to one or more of the item packages for the various fulfillment centers. Other costs that may be added by the planning service may include, but are not limited to, labor, overhead, corrugate, dunnage, etc. Any one of or combination of the transportation costs, load balancing factor, and other costs are referred to herein generally as the “total fulfillment cost” or “estimated total fulfillment cost” and specifically as “custom container total fulfillment cost” or “estimated custom container total fulfillment cost” for item packages recommended for shipment in a custom container and “standard container total fulfillment cost” or “estimated standard container total fulfillment cost” for item packages recommended for shipment in a standard container.

Once the total fulfillment cost for each item package from each fulfillment center has been determined, the planning service 203 determines a combination of item packages from respective fulfillment centers that will satisfy the customer's order and provide the lowest cost to ship the items to the custom—referred to herein as the lowest total fulfillment cost combination. Continuing with the above example, the planning service may determine that the lowest cost combination for the customer's order of items A, B, and C is to ship an item package of {A, C} from FC-1 207 using a custom container and ship an item package of item {B} from FC-2 209 using a standard container.

Referring now to FIG. 2C, upon determining a lowest total fulfillment cost combination of item packages from respective fulfillment centers, the planning service provides item package fulfillment instructions to the respective fulfillment centers for shipping of the various item packages in the container(s) determined to provide the lowest total fulfillment cost for the order. For example, the planning service may issue an item package fulfillment instruction to FC-1 207 requesting fulfillment of item package {A, C} using a custom container formed according to the recommended custom container dimension values and issue an item package fulfillment instruction to FC-2 209 to fulfill item package {B} using the recommended standard container.

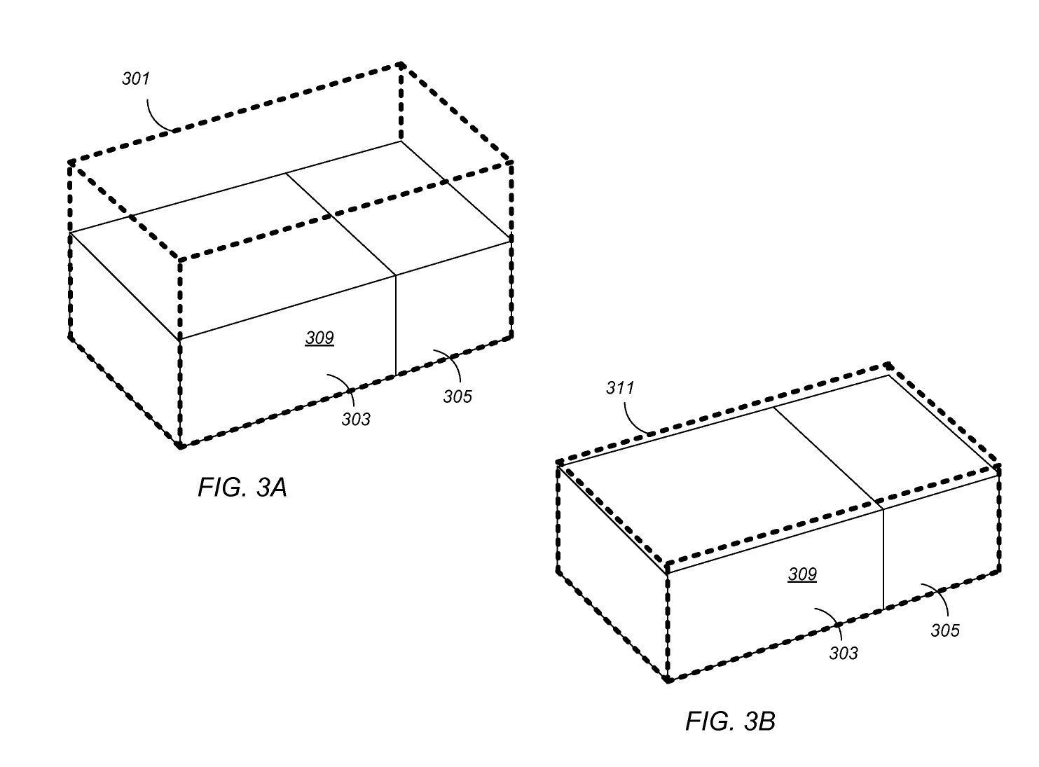

FIGS. 3A-3B illustrate examples of a how a container recommendation service may select a standard container 301 to recommend for shipping an item package 309 of two items 303, 305 and determined custom container dimension values to recommend for forming a custom container 311 for shipping the same item package 309 of two items 303, 305 (FIG. 3B). In some embodiments, the container recommendation service may be configured to recommend various containers suitable for shipping the item package 309 dependent on item dimension values currently associated with the items 303, 305 of the item package 309 and/or dimensions associated with the item package 309 itself. For example, the container recommendation service may recommend a particular container suitable for shipping an item package 309 based on known or estimated dimension values of the items 303, 305 in the item package 309 (e.g., item dimension values provided by the vendors of each of the items, measured by agents or systems in the facility, and/or estimated as described herein). In one embodiment, the container recommendation service may base its decision on item dimensions gathered through an automated dimensioning process (e.g., one employing a CubiScan® system), and may have a fairly high level of accuracy. In other embodiments, the item dimensions used in recommending a container may be estimated based on information received from a manufacturer or supplier of the items, or based on a process of successive approximation as the items are handled within the facility. In many cases, knowing the exact dimensions of an item may not be necessary for selecting a standard container or custom container dimensions into which a group of items can be placed, because the “practical” or estimated dimensions of the items may provide a size range accurate enough to select a standard container from among a finite set of container or form a custom container within a percentage of dimension tolerance to ensure that the item or group of items will fit.

In some embodiments, the container recommendation service may make particular assumptions about item dimensions or may assign item dimensions according to a standard algorithm, or company policy, in order to facilitate the recommendation of containers for item packages. For example, in one embodiment, the item dimension having the largest value may be designated to be the “height,” the dimension having the second largest value may be designated to be the “length,” and the dimension having the smallest value may be designated to be the “width” of the item. In such embodiments, the dimensions of containers may also be designated using the same assumptions. In other embodiments, different assumptions or assignments may be made or the designation of length, height, and width dimensions of items or containers may be arbitrary. In some embodiments, standards or policies may specify other aspects of the operations of the materials handling facility, such as a default placement or orientation for certain items within containers or a specific bin-packing algorithm to be assumed when recommending containers and/or estimating the cube utilization of an item or group of items if placed in a particular candidate container. For example, various policies may specify that the largest (and/or heaviest) item in a group should be placed horizontally along the bottom of the shipping containers and smaller items placed on top of the larger items.

As noted above, known and/or estimated item dimension values may be used to identify standard containers 301 whose volume and/or dimensions are appropriate for handling the item package 309. In addition, in some embodiments, the dimension values and/or volume of the packaging materials and any other non-item contents may also be considered when recommending a standard container 301 for the item package 309 or a custom container 311 for the item package 309. For example, the item package 309 dimensions and promotional inserts, fill material dimensions and/or gift wrapping may be supplied to the container recommendation service as an input and may be used in determining the appropriate standard container and custom container dimension values for collectively handling the item package and non-item contents.

In one embodiment, the volume of an item package 309 may be defined to be equal to the volume of a three-dimensional bounding box having length, width, and height equal to the length, width, and height of the items contained in the item package when arranged for packing, and the volume of a container may be defined to be the maximum volume of the interior of the container. In some embodiments, the volume and dimensions of a group of items may be defined, respectively, to be the volume and corresponding dimensions of a three-dimensional bounding box having sufficient length, width, and height to contain all of the items in the item package. For example, in FIG. 3A, a container recommendation may be determined using a particular packing algorithm that calculates the volume of a bounding box surrounding the items 303, 305. This may be done according to guidelines and conventions for packing one or more items (e.g., the packing algorithm may specify that the largest and/or heaviest item should be placed horizontally on bottom of the container first and additional items may be placed on top of, or next to, this item in order of their largest dimension value, their weight, etc.). In another embodiment, the system may be configured to calculate a volumetric utilization (e.g., the percentage of the container that would be filled by the item(s) and any non-item contents) for the item(s) when placed in containers of various sizes and shapes.

Based on the calculated volumetric utilization of the item package, the system may then recommend a standard container 301 that is available within the fulfillment center that will maximize the volumetric utilization and recommend custom container dimension values for use in forming a custom container 311 (FIG. 3B) that maximizes volumetric utilization. In FIG. 3B, the custom container 311 has dimensions that are large enough to ship the item package 309. In one example, the dimensions of the custom container 311 may be slightly larger than the calculated volume of the item package 309 to ensure that the agent packing the custom container 311 with the items 303, 305 has sufficient room for the items 303, 305 or to account for item dimensions that may not be precise. While the examples contained herein use the definitions described above, other embodiments may use other definitions of volume and/or volumetric utilization, or may not use a determination of volume or volumetric utilization as part of a container recommendation process.

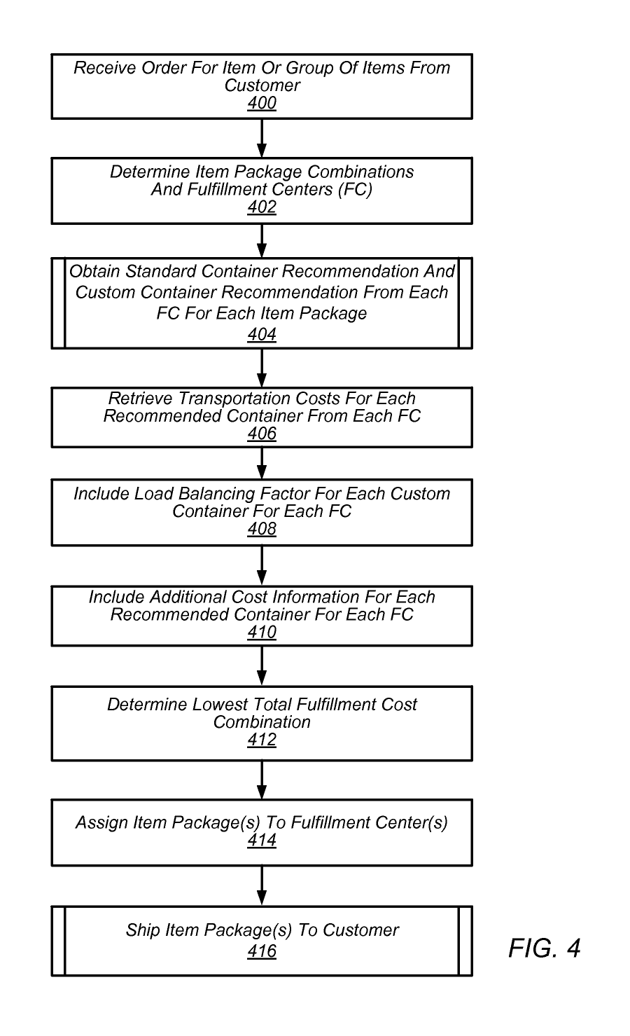

FIG. 4 is a flow diagram illustrating an example process for selecting a standard container or custom container for use in shipping items. In this example, the process may include receiving an order for an item or group of items that are to be packaged and shipped to a customer, as in 400. In various embodiments, this indication may take the form of a recommendation list, pick list, item package fulfillment instructions, inventory list, order list, packing list, etc., and may be a physical list, such as a printed list, or may be a virtual list, such as may be contained in a memory accessed directly by a container recommendation service, or such as may be displayed on a monitor, handheld device, or other suitable display mechanism. In some embodiments, such a list may be scanned automatically or by an agent in the materials handling facility.

Once the item or items to be shipped to the customer are known, the planning service may determine all available item package combinations and fulfillment centers from which those item packages can be shipped, as in 402. For example, if the customer orders three items, such as items A, B, and C, the shipment splitting service may identify five different item package combinations: {A, B, C}, {A} {B} {C}, {A, B} {C}, {A, C} {B}, {B, C} {A}. Based on those combinations the planning service may determine which fulfillment centers are capable of shipping each item package. For example, the planning service may determine that FC-1 can package and ship any of the different item package combinations, that FC-2 can ship item packages {A}, {C} and {A, C} and FC-3 can ship item package {B}.

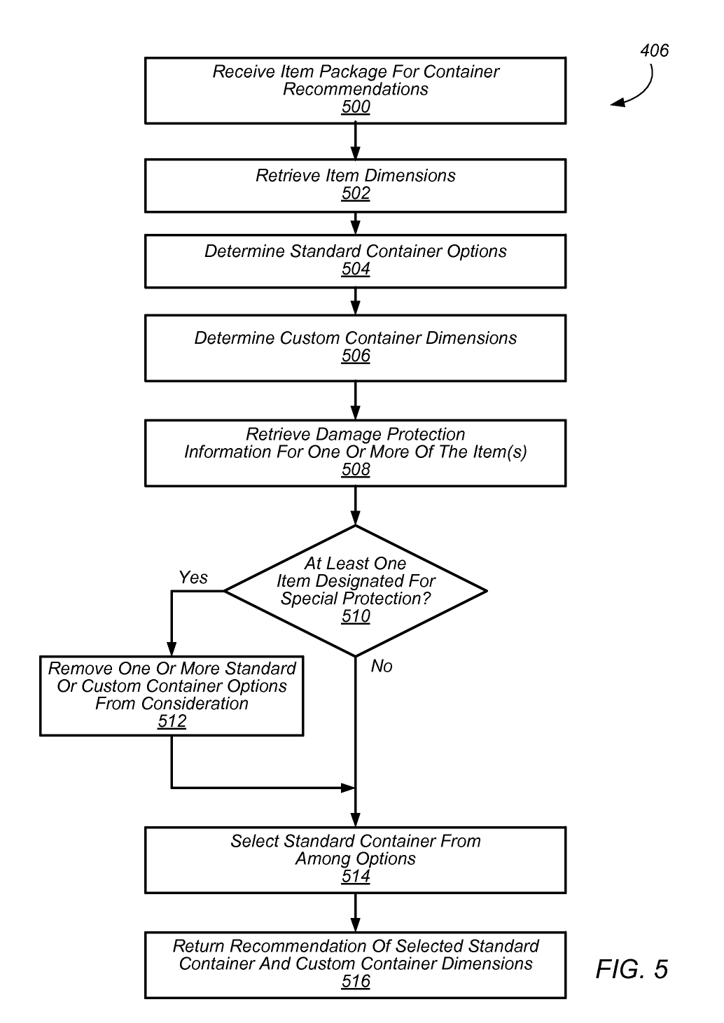

After determining the different combinations of item packages and which fulfillment centers are able to package and ship the item packages, the packaging information system obtains at least one standard container recommendation and a custom container dimension recommendation for each item package, as in sub-process 404. In one example, this information may be obtained from a container recommendation service at each fulfillment center for each item package the fulfillment center can package and ship. In another embodiment, a global container recommendation service with knowledge of what standard containers are available at each fulfillment center may generate standard container and custom container dimension value recommendations that can be satisfied by each fulfillment center for each item package combination. Alternatively, the requests for a recommended standard container and custom container for each item package may be sent to different services. For example, a request for a recommended standard container may be sent to a container recommendation service at one or more fulfillment centers to obtain a recommended standard container from each of those fulfillment centers. The request for custom container dimension values may be sent to a global container recommendation service that is able to recommend custom container dimension values for each fulfillment center capable forming a custom container and shipping the item package. In such an example, the recommended custom container dimension values may be the same for all fulfillment centers and thus only one response is provided. Alternatively, the recommended custom container dimension values may be different for one or more fulfillment centers and thus multiple responses provided—one for each of the different recommended custom container dimension values. For example, some fulfillment centers may have different custom container forming devices that form custom containers of differing dimensions. FIG. 5, discussed below, provides additional information describing one example for recommending one or more standard containers and one or more custom containers for each item package.

Utilizing the recommended standard containers and the recommended custom container dimension values for each item package from each fulfillment center, the packaging information system may obtain estimated transportation costs, as in 406. For example, the system may obtain the estimated transportation costs to ship each item package in each recommended container (standard and custom) from each of the fulfillment centers to the customer. In some embodiments, this may be done for each combination of item package, fulfillment center, and container. In other embodiments, the costing may be done more iteratively. For example, the system may obtain a standard container transportation cost estimate for shipping an item package from FC-1 in a standard container as well as a custom container transportation cost estimate for shipping that item package from FC-1 in a custom container. The system may then query whether the transportation cost for the same item package in either a standard container or custom container is lower if shipped from FC-2. If the transportation cost to ship the item package from FC-2 is not lower than the costs to ship from FC-1, the system will not obtain the costs from FC-2. This iterative process may be repeated for each identified fulfillment center. If a subsequent set of cost estimates is lower, for example the estimated transportation cost to ship the item package from FC-3 is lower than the estimated cost to ship the item package from FC-1, the transportation cost estimates from FC-3 will be used to compare with any remaining fulfillment centers for that item package.

Once each estimated transportation cost has been retrieved for each recommended container from each fulfillment center for each package combination, the packaging information system may include an additional load balancing factor or cost to the estimated custom container transportation costs for each recommended custom container, as in 408. A load balancing factor may be added to distribute routing of item packages for packaging within a fulfillment center between packing stations with custom container forming devices and those without, so that overall throughput of the fulfillment center remains as high as possible. Accordingly, the load balancing factor may vary between fulfillment centers and may also vary within a fulfillment center depending upon the overall load of the fulfillment center, the load of the packing stations and the number of packing stations with custom container forming devices. For example, a fulfillment center with twenty-five total packing stations, only five of which have custom container forming devices may apply a load balancing factor of $2.00 to the estimated custom container transportation cost for each custom container recommendation. In comparison, another fulfillment center with twenty-five total packing stations, ten of which have custom container forming device may apply a load balancing factor of $1.00 to the estimated custom container transportation costs for each recommended custom container.

As the number of item packages recommended for custom containers increases within a fulfillment center, the load balancing factor may also increase to reduce the number of custom containers that are recommended and keep the load across packing stations balanced. This adjustment may be done real-time based on actual load within the fulfillment center, predictably based on actual historical loads experienced within the fulfillment center, anticipated loads within the fulfillment center, some combination thereof, or based on other factors. For example, the load balancing factor may vary throughout the day depending upon expected or anticipated load within the fulfillment center. The expected or anticipated load may be based upon past load over the last few days, weeks or years, or load during the same or similar period of time in prior years (e.g., holiday shopping). An additional multiplier may be added to historical loads to account for growth or reduction in the overall system or shipping demand. In addition to varying the load balancing factor based on historical information, the load balancing factor may be adjusted up or down real-time based on the actual load experienced by the fulfillment center. While the examples discussed herein primarily focus on utilizing a load balancing factor to balance loads across packing stations with a materials handling facility, such as a fulfillment center, in other examples, the load balancing factor may be applied to balance load across packing stations of multiple materials handling facilities.

Adjusting the load balancing factor enables the packaging information system to regulate the number of item packages that are recommended custom containers and routed to packing stations with custom container forming devices, thereby reducing the risk of a backlog of pack jobs that need to be completed at those packing stations. In addition, regulating the number of item packages that are recommended custom containers also helps reserve capacity for future orders that will benefit from custom containers. Still further, load balancing through use of a load balancing factor or cost that is added in to the estimated custom container transportation cost will increase the savings for item packages that are recommended custom containers as the load balancing factor is increased.

In addition to adding a load balancing factor to the estimated custom container transportation cost, the packaging information system may also include other additional costs, referred to herein as standard container additional costs or custom container additional costs, to determine a total fulfillment cost for the item package, container, fulfillment center combination, as in 410. Examples of additional costs may include, but are not limited to, fulfillment center overhead cost, cost of corrugate for the packaging (the cost of corrugate for a custom container may be higher than the cost of corrugate for a standard container), custom container forming device use cost, the agent cost, materials handling cost, depreciation costs of the custom container forming device, etc. In various examples described herein, the total fulfillment cost can be any one or combination of the transportation costs, load balancing factor or cost, and any one or more of the additional costs. For example, the total fulfillment cost utilized by the packaging information system may only include the estimated transportation cost. Alternatively, the estimated total standard container fulfillment cost for a standard container may include the estimated standard container transportation cost whereas the estimated total custom container fulfillment cost for a custom container may include the estimated custom container transportation cost and the load balancing factor for custom containers.

Once the total fulfillment cost for each recommended item package, container, and fulfillment center combination has been determined, the planning service determines the lowest total fulfillment cost combination that will result in delivery of the items ordered by the customer, as in 412. Referring again to the example of three ordered items (A, B, C), the packaging information system may determine that the lowest total fulfillment cost combination is to ship an item package of {A, C} from FC-1 using a custom container and an item package {B} from FC-3 using a standard container. In addition to total cost, many additional factors may be considered in selecting the item package, fulfillment center, container combination for shipping of ordered items. In some embodiments, the lowest total fulfillment cost combination may also depend on the customer to whom the item is to be shipped, an applicable service level agreement, the destination of the item, the shipping carrier selected for shipping the item, item affinity information, an indicator of the fragility of the item, the weight of the item, an environmental constraint associated with the item (e.g., a restriction on the temperature and/or humidity at which the item should be held during shipping), and/or the remaining inventory of the item within each fulfillment center.

Based at least in part on the lowest total fulfillment cost combination, the planning service generates an item package fulfillment instruction for each item package that is assigned to the corresponding fulfillment center, as in 414. In one example, the item package fulfillment instruction includes an identification of the fulfillment center, the items to be included in the shipment and the container type (e.g., custom container or standard container). In other embodiments, additional or fewer items of information may be included in the item package fulfillment instruction. For example, the order request, instead of identifying the container type, it may identify the container dimension values for a custom or standard container. Other types of information that may be included in item package fulfillment instructions include, destination information, shipping priority (e.g., overnight, ground, etc.), identification of fragile, hazardous or others unique items, and the like.

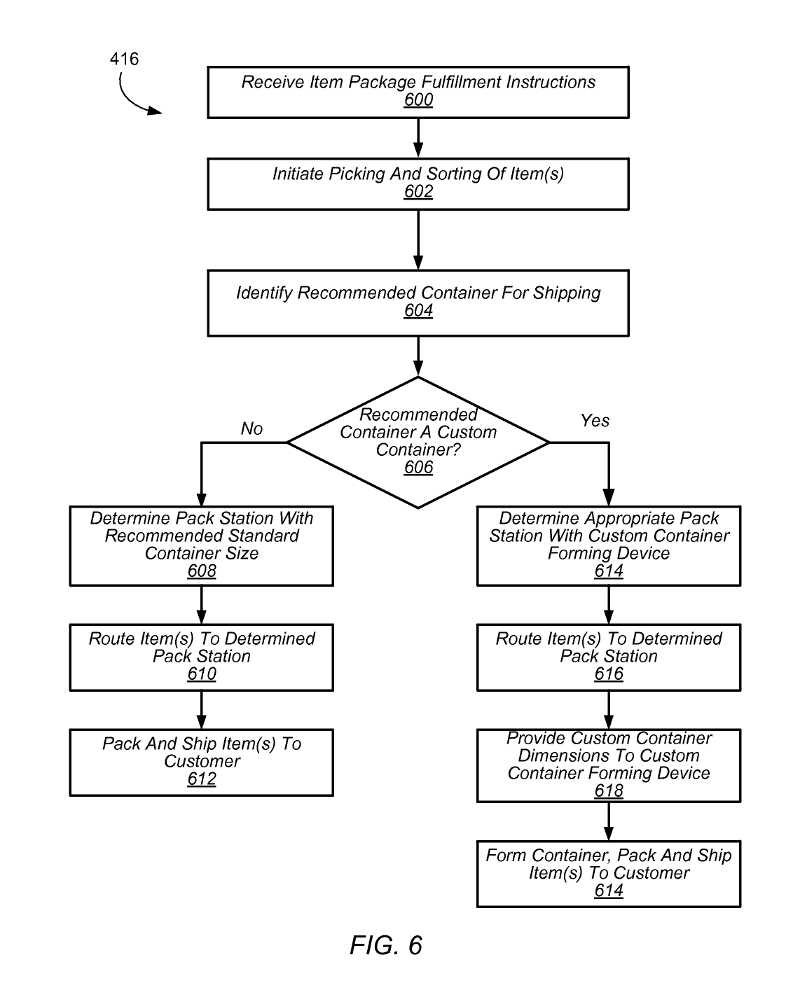

In response to receiving an item package fulfillment instruction, the fulfillment center executes the picking, packing and shipping of items identified in the item package fulfillment instruction, as in sub-process 416. Sub-process 416 of picking, sorting, packing and shipping an item in response to receiving an item package fulfillment instruction is described in further detail below with regard to FIG. 6.

In an alternative embodiment, rather than determining estimated transportation costs for both a recommended custom container and a recommended standard container for each fulfillment center, at 404 the system may only obtain standard container recommendations from each fulfillment center for each item package and determine estimated transportation costs for those recommended standard containers, as in 406. In such an example, the load balancing factor and additional cost information may not be added and the service may determine a lowest total fulfillment cost combination based on the estimated transportation costs for the recommended standard containers, as in 412, and assign the item package(s) to the identified fulfillment center(s), as in 414. The receiving fulfillment center may then determine recommended custom container dimension values for the assigned item package and obtain an estimated transportation cost for transporting the item package in the recommended custom container. Estimated total fulfillment costs may also be determined for both the recommended standard container and the recommended custom container by including a load balancing factor to the estimated transportation cost for the custom container and including any additional cost information to the estimated custom container transportation cost and the estimated standard container transportation cost. Based on the estimated total fulfillment costs determined at the fulfillment center, it may be determined whether to ship the item package from the assigned fulfillment center in the recommended standard container or a custom container having the recommended custom container dimension values.

In still another implementation, at 404 the system may determine custom container dimension values for each item package combination and determine estimated transportation costs based on a custom container having the determined estimated dimension values, as in 406. In such an example, the load balancing factor and additional cost information may not be added and the service may determine a lowest total fulfillment cost combination based on the estimated transportation costs for the recommended custom containers, as in 412, and assign the item package(s) to the identified fulfillment center(s), as in 414. The receiving fulfillment center may then determine a recommended standard container for the assigned item package and obtain an estimated transportation cost for transporting the item package in the recommended standard container. Estimated total fulfillment costs may also be determined for both the recommended standard container and the recommended custom container by including a load balancing factor to the estimated transportation cost for the custom container and including any additional cost information to the estimated custom container transportation cost and the estimated standard container transportation cost. Based on the estimated total fulfillment costs determined at the fulfillment center, it may be determined whether to ship the item package from the assigned fulfillment center in the recommended standard container or a custom container having the recommended custom container dimension values.

In some embodiments, item dimensions (e.g., known item dimensions or estimated item dimensions determined by an automated product dimension estimator) may be used to recommend suitable containers (standard or custom) which may be used in shipping item packages to a customer. In some embodiments, additional information may be used to exclude the selection of containers that are unsuitable for handling items needing special damage protection. One such embodiment is illustrated in the sub-process diagram 406 in FIG. 5. In this example, the process may include receiving an indication of an item package for which container recommendations are requested, as in 500. Once the item package identifying the item or items to be handled are known, the container recommendation service may retrieve any estimated or known values of the dimensions (and/or volumes) of the item(s) or item package, as in 502. In some embodiments, estimated or known dimensions and/or volumes of various items of the item package may be retrieved from a table or database, such as Table 1, described below.

In some embodiments, a container recommendation service may be configured to determine one or more recommended options for a standard container for handling the item package based on the estimated volume and/or dimensions of each of the items or item package, as in 504. In some embodiments, the container recommendation service may calculate overall dimensions of the item(s) as well as dimensions of any required non-item contents (if any). In such cases, the container recommendation service may recommend the smallest available standard container(s) in which the item package will fit based on the overall dimensions of the item package. In other embodiments, the container recommendation service may use a bin-packing algorithm to determine, for each available container, whether or not the item(s) of the item package will fit in the container. In some embodiments, the container recommendation service may start by determining if the items will fit in the smallest available standard container and if not, repeating its determination for each other standard container, from smallest to largest, to determine whether the items will fit into one or more of the standard containers. In other embodiments, the identification of suitable containers for handling the item(s) may be performed in other manners. For example, the container recommendation service may track standard container types that have previously been used to handle the item(s), or similar sized items, and retrieve an indication of one or more appropriate standard containers for handling the current item package based on a stored mapping for those contents.

In addition to determining one or more standard container options, the container recommendation service may be configured to determine custom container dimension values for use in forming a custom container for the item package based on the estimated volume and/or dimensions of each of the items or the item package, as in 506. In some embodiments, the container recommendation service may calculate overall dimensions of the item package as well as dimensions of any required non-item contents (if any). In such cases, the container recommendation service may determine custom container dimensions that match the overall dimensions of the item(s) as well as dimensions of any required non-item contents. Alternatively, the container recommendation service may determine custom container dimension values that are a percentage (e.g., 2%) or size (e.g., 0.25 inches) larger in one or more dimensions than the overall dimensions of the item package and any non-item contents. In other embodiments, the container recommendation service may use a bin-packing algorithm to determine the appropriate dimensions for the custom container. In some embodiments, the container recommendation service may start by determining if a custom container has previously been formed for the item package to be handled and confirm whether the custom container was too small for the items (e.g., the custom container was not used or used for only a portion of the items), too large for the container (e.g., the packing agent identified the customer container as being too large, large amounts of dunnage were included in the container), or appropriate for the items. In other embodiments, the determination of custom container dimension values may be performed in other manners.

As illustrated in the example in FIG. 5, once one or more recommended standard container options and the recommended custom container dimension values have been determined, the process may include retrieving damage protection information for one or more of the items of the item package, as in 508. For example, the container recommendation service may access one or more databases that store information about the items stored in the materials handling facility. In one embodiment, information associated with each item identifier may include a flag or parameter value to indicate whether or not the item is designated as one for which special protection is recommended or required. In another embodiment, a database may store a list of the identifiers of items that have been designated for special protection. If at least one item of the item package is designated for special protection, shown as the positive exit from 510, the method may include removing one or more of the recommended standard container options and/or the custom container options from consideration, as in 512. In other words, the process may include the container recommendation service removing from consideration any containers that are unsuitable for handling items that need additional (or at least better) protection from damage during shipping. For example, if a plate to be shipped has been designated as needing special damage protection, all mailing envelopes may be excluded from consideration, even those whose sizes indicate that they may be suitable for shipping the plate.

Once one or more unsuitable container options have been removed from consideration (or if no options are removed from consideration because no items are designated for special protection), the process may include selecting a standard container from among the recommended options, as in 514. In other words, a recommended standard container may be selected from among the options determined at 504, or from a pared down version of that list of standard container options (e.g., pared down as in 512). The container recommendation service may then return an indication of the selected standard container recommended for use and recommend custom container dimension values for use in forming a custom container, as in 516, unless the custom container was filtered out as inappropriate due to special protection designation for one or more of the items to be handled (e.g., pared down as in 512).

FIG. 6 is a flow diagram illustrating one embodiment of a process for picking, sorting, packing and shipping an item. As illustrated in the example in FIG. 6, once the lowest total fulfillment cost combination of item packages, containers, and fulfillment centers for satisfying a customer's order are known, the process may include receiving item package fulfillment instructions for use in fulfilling the customer's order, as in 600. Upon receiving an item package fulfillment instruction, picking, packing and sorting of items identified in the item package fulfillment instruction is initiated, as in 602. This may include generating a picking request that is completed by one or more picking agents for retrieving the item(s) included in the item package from the inventory of the fulfillment center and routing those items to a packing station.

In addition to initiating the picking and sorting of items of the item package for shipment, the recommended container for shipping is identified, as in 604. As discussed above, the recommended container may be identified in the item package fulfillment instructions. Alternatively, a request may be submitted to the container recommendation service of the fulfillment center to obtain an identification of the recommended container. In such an example, the container recommendation service may maintain an identification of the container (standard or custom) for that item package based on the initial request and response between the planning service and the container recommendation service, discussed above.

Once the recommended container for the item package is identified, it is determined whether the recommended container is a custom container or a standard container, as in 606. If it is determined that the recommended container is a custom container, as illustrated by the positive exit from 606, a packing station with a custom container forming device capable of forming the recommended custom container is determined, as in 614. In one example, even though the custom container forming devices may be capable of forming containers of numerous dimensions, the range of dimensions with which a particular custom container forming device may form containers may be restricted. For example, the packaging information system may restrict a particular custom container forming device to only forming small containers from a single blank of corrugate, such as a 22 inch wide corrugate blank. Likewise, another custom container forming device may be restricted to only forming medium sized containers from a larger blank of corrugate (e.g., 26 inch wide corrugate blank) and a third custom container forming device may be restricted to only forming large custom containers from yet another, larger blank of corrugate (e.g. a 36 inch wide corrugate blank). By restricting the dimensions with which custom container forming devices are allowed to form custom containers, the downtime required to reposition components of the device is reduced, thereby increasing the throughput of the packing stations.

Upon identifying the appropriate packing station for the custom container, the items are routed to the determined packing station, as in 616. This may include routing the picking of items to particular bins or sorting stations within the fulfillment center or routing the sorting of those items to particular packing stations. In addition to routing items to the identified packing station, the custom container dimension values for use in forming a custom container are provided to the custom container forming device located at the identified packing station, as in 618. The custom container forming device may then form the custom container once the items arrive at the packing station and one or more packers at the packing station may pack the items into the custom container once formed, as in 614.

If however, it is determined that the recommended container is not a custom container, as illustrated by the negative exit from 606, the appropriate packing station with the recommended standard container size is identified, as in 608, and the items of the item package are routed to the determined packing station, as in 610. Once all of the items have arrived at the determined packing station, one or more agents at the packing station may pack the items in the standard container for shipping to the customer, as in 612.

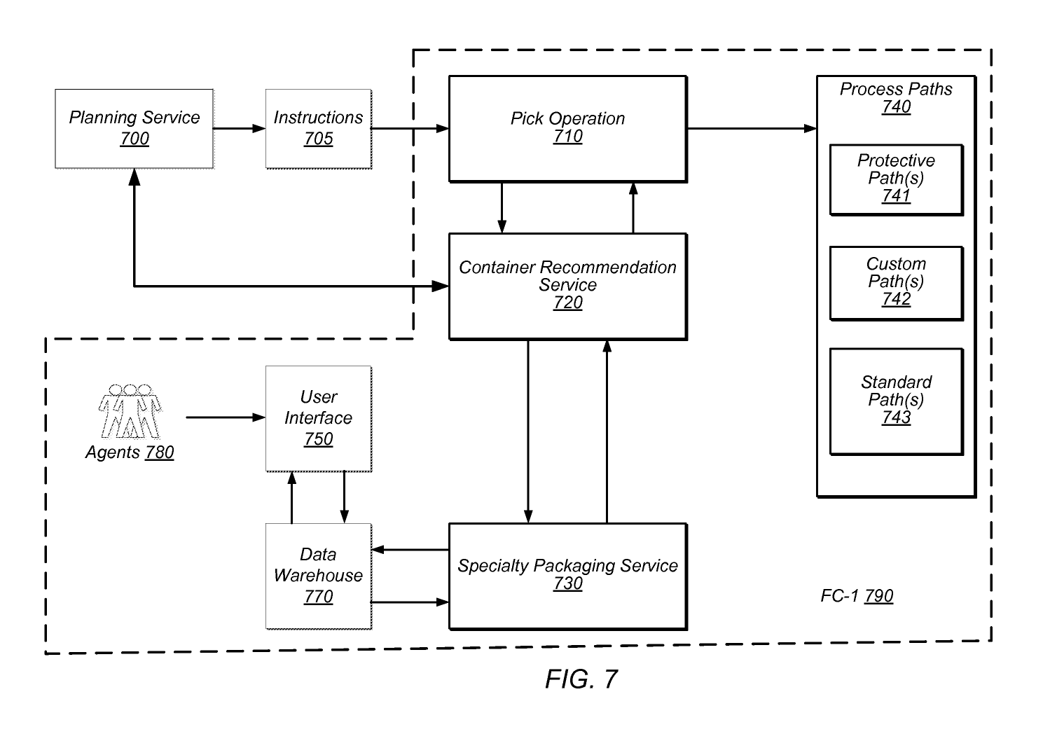

FIG. 7 is a block diagram illustrating one embodiment of a system for processing orders and recommending containers (including standard containers and custom containers) for handling one or more item packages (e.g., for shipping) based on physical characteristics of the items, such as physical dimension values, cost for shipping the items, and feedback related to item deliveries. In this example, the system includes a planning service 700, pick operation 710, a container recommendation service 720, a specialty packaging service 730, various process paths 740, a user interface 750 (through which various agents 780 interact with the system), and a data warehouse 770, which may store (and may provide to other components of the system) a protected item list (not shown).

In this example, the inputs to the system may include an order of one or more items from a customer. The planning service 700, which may communicate with one or more ordering systems and with one or more materials handling facilities, may receive an order from a customer (not shown) for one or more items. The planning service 700 may determine each combination of fulfillment centers, such as FC-1 790, and item package combinations that can be used to fulfill the received order. For each item package and fulfillment center combination, the planning service 700 may issue a container recommendation request, which may include identifiers of one or more items to be shipped to a customer in response to receiving an order, to the container recommendation service of a fulfillment center capable of shipping the items. For example, FIG. 7 illustrates communication between the planning service 700 and the container recommendation service 720 of fulfillment center FC-1 790. The request is issued to the container recommendation service 720 in order to obtain an indication of a recommended standard container and recommended custom container dimension values for a custom container in which to package the item(s) identified in the container recommendation request.

Additional inputs to the system for the given container recommendation process, which may also be provided to or retrieved by the container recommendation service 720 and the planning service 700, may include, but are not limited to: item dimensions, item weights, standard container dimensions, list of available standard container types and sizes, standard container costs, capabilities of custom container forming devices, corrugate cost for forming custom containers, packaging costs, shipping options, and/or an identifier of the materials handling facility to be used to fulfill the order. The outputs of the given container recommendation service 720 may include an identification of a standard container for the item package and/or custom container dimension values for use in forming a custom container. Note that various inputs may be retrieved from the data warehouse 770, may be input by one or more agents 780, or may be obtained from other sources (not shown), such as other fulfillment centers.

In this example, the data warehouse 770 may also store customer feedback data and/or concession information, and this feedback and/or concession information may be used to update a protected item list (not shown). The data warehouse 770 may also include feedback information from agents 780 and/or the packing stations identifying whether the recommended container (standard or custom) was too small, too large or the appropriate size. For example, during packing, an agent 780 may directly identify the recommended container as too small by providing input into the system via user interface 750 or indirectly by only packing a portion (or none) of the items in the recommended container and the remainder of the items in one or more separate containers. In a similar fashion, the recommended container may be identified as too large via direct input by the packing agent or indirectly by the system determining that the agent utilized large amounts of dunnage to fill empty space in the recommended container after the items have been placed in the container.

In the example illustrated in FIG. 7, agents 780 may view and/or update the protected item list and provide feedback on whether the recommended container was too small, too large, or the appropriate size through user interface 750. For example, agents 780 may select an indicator (e.g., too small, too big, appropriate) on user interface 750 to provide feedback on whether the recommended container was the appropriate size for the items.

Based on the information collected by the container recommendation service 720, it will determine and recommend back to the planning service 700 a standard container for use in packaging and shipping the item package and custom container dimension values for use in forming a custom container to package and ship the item package. The container recommendation service 720 may also maintain a record of the containers recommended for the item package.

The planning service 700, upon receiving container recommendations for each fulfillment center, item package combination, will determine the total cost to ship the item packages in the different containers from each fulfillment center and determine the lowest total fulfillment cost combination of containers, item packages and fulfillment centers for shipping that will satisfy the customer's order. As discussed above, the total fulfillment cost may include any one or more of transportation costs, load balancing factors for custom containers, labor cost, agent cost, materials handling cost, custom forming device cost, fulfillment center overhead cost, etc. Once the planning service 700 determines the lowest total fulfillment cost combination, it generates item package fulfillment instructions for each item package and delivers those instructions to the appropriate fulfillment center, such as fulfillment center FC-1 790. The item package fulfillment instructions 705 may include, among other information, a list of items to be picked, packed and shipped and the type of container to use in packaging the items.

Continuing with this example, the pick operation 710 may pass the item package fulfillment instructions 705 back to the container recommendation service 720 and/or pass the item package fulfillment instructions to specialty packaging service 730 in order to obtain an indication of a recommended container in which to package the item(s) included on the item package fulfillment instructions 705. In this example, pick operation 710 may require this information in order to determine which of the process paths 740 the picked item(s) should be routed for packaging and shipping.

If the item(s) do not require special protective packaging and a standard container is recommended, the item(s) may be routed to one of several standard process paths 743. The standard process paths 743 include packing stations stocked with standard containers that are available for use in packaging the item package. This process path may be used in scenarios in which standard exclusion rules may be applied (such as a rule stating that if a mailing envelope or variable depth folder is excluded from consideration when shipping a light bulb, the item may be packaged in a standard corrugated box on this process path). If the item(s) require protective packaging, they may be routed to a protected process path 741. This process path may lead to a packing station at which special protective packaging material (not available on standard process paths) is available. One or more of the packing stations in the protected process path 741 may also include custom container forming devices thereby allowing protective packaging material to be used in conjunction with a custom container. If the item(s) are recommended for packaging in a custom container and not designated for protective packaging, they may be routed to custom process path 742. This process path leads to stations that include one or more custom container forming devices that receive the recommended custom container dimension values and form the custom container for use in packaging the items.

In this example, the method may include receiving an indication of a container actually used to handle the item(s). For example, a packing agent or automated packing mechanism may scan each of the items as they are packed in a box for shipping, as in 802. This information (e.g., an identifier of each of the items and an identifier of the box) may be provided to the packaging information system (or an inventory management system thereof) automatically as the items and box are scanned, or may be explicitly provided at a later time (e.g., it may be uploaded when the packaging is complete and/or may include other feedback from the agent or automated operation).

In some embodiments, if a recommended container is inappropriately sized for handling the item(s), an agent or automated mechanism may select a more suitable container for the item(s) and feedback may be sent to the container recommendation service indicating that a recommended container was not used or that additional containers were also used. This indication may be received from an agent, in some embodiments, or from an automated feedback mechanism of various operations of the materials handling facility. For example, if items and containers are scanned when the items are placed in a container for shipping (and the scanned information is input into the packaging information system, or an inventory management system thereof), the system may receive an indication of the container(s) in which the item(s) were actually handled. In some embodiments, a packing system may include a scanner or sensors and software to detect that one or more items are sticking out of a box, that a box will not close, or that a box is half-empty, and may be configured to select a different box for the item(s). In other embodiments, an agent of the materials handling facility, such as a picking, sorting or packing agent, may detect that a recommended container is not appropriate for the group of items intended to be placed in it and may provide an indication to the packaging information system (or an inventory management system thereof) to that effect and/or that one or more of the item dimension values for those items may be inaccurate.

In yet another example, if the item package is designated for a custom container, a portion of the custom process path 742 (FIG. 7) may include an item dimensionalizer (e.g., Cubiscan) that scans and determines the actual dimensions of each item to be handled prior to forming of the custom container. This process may include determining the appropriate arrangement of the items for placement in the container to optimize usage of the container and based on that configuration determine an overall volume for the item package. The determined overall volume may then be compared with, or used as, the custom container dimension values for forming the custom container. When using the determined actual volume of the item package to confirm that the recommended custom container dimension values are sufficient to handle the item package (including the items and any non-item contents), the system may include a buffer or additional volume in the custom container to ensure that the item package will fit. For example, if the actual volume of the item package is determined to be 7 inches×4 inches×3 inches, the system may require that the custom container dimension values be at least 7.25 inches×4.25 inches×3.25 inches.

Likewise, the system may also use the determined actual volume of the item package to ensure that the dimensions provided for the custom container are not too big. Continuing with the above example, the system may also set an upward bound specifying that the custom container dimensions do not exceed, for example, 8 inches×5 inches×4 inches. Using the determined actual volume of the item package to place threshold ranges between which the custom container dimensions are to be set increases the likelihood that the custom container, when formed, is the appropriate size to handle the item package.

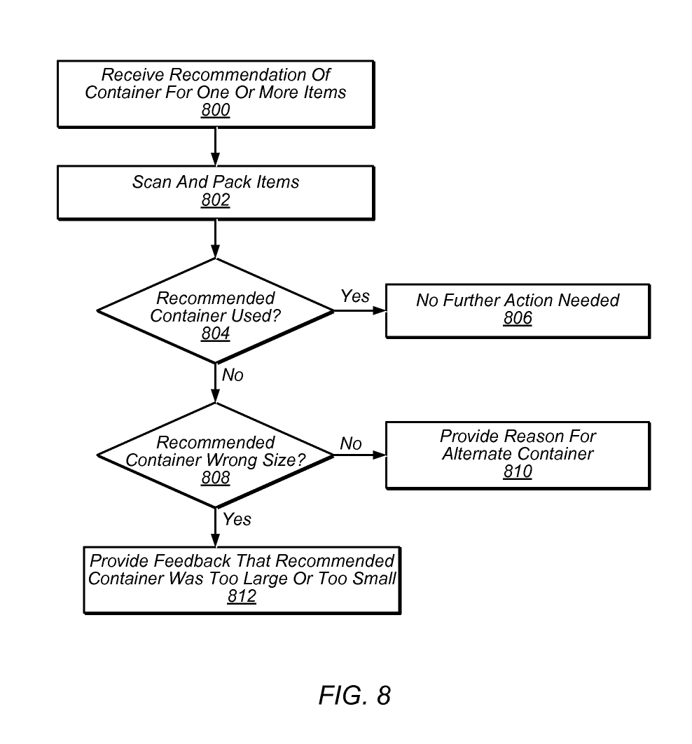

As illustrated in FIG. 8, the method may include comparing the recommended container and the actual container used, as in 804. For example, in one embodiment, the packaging information system (or a component thereof) may compare an identifier of the actual container (e.g., one received as feedback from an agent or automated operation) with an identifier of the recommended container to see if they match. Using this comparison, the packaging information system (or a component thereof) may detect that a recommended container was not used and/or that the item(s) were placed in a container smaller or larger than one recommended based on currently stored item dimension values for the item(s). Other methods of performing a comparison between an actual and a recommended container may be performed, in other embodiments.

In some embodiments, if the item(s) were packed in the recommended container, shown as the positive exit from 804, no further action may be required on the part of the agent and/or automated system for this item package, as in 806. In other embodiments, the method may include storing an identifier of the recommended container and/or the actual container along with information about the item(s) for further analysis (not shown). For example, a performance tracking operation of the materials handling facility may review the number of correctly recommended containers (standard and custom) for different item packages and/or for item packages that include particular items in order to detect any issues with the container recommendation process. In general, any information collected as part of the packing operation may be stored in one or more tables, databases, or other data structures for further analysis.

If, however, the item(s) were not packed in the recommended container, shown as the negative exit from 808, feedback may be provided to the packaging information system (or a component thereof). In some embodiments, an agent may provide feedback indicating one or more reasons why the recommended container was not used, such as it was smaller or larger than necessary, or that the recommended container was not available. In the example illustrated in FIG. 8, if feedback from an agent or an automated operation indicates that the recommended container was not used because it was the wrong size for the item package (e.g., if it was too small, was larger than necessary to contain the item(s), or was the wrong shape to contain them), shown as the positive exit from 808, this information may be included in feedback provided by the agent or automated system, as in 812. In this case, the packaging information system (or a component thereof) may, in some embodiments, incorporate this additional information when updating a value or confidence level for one or more dimension values for one or more of the items. If, on the other hand, the recommended container was appropriately sized for the item(s) but was not used, shown as the negative exit from 808, the agent or automated system may provide feedback regarding the reason that the recommended container was not used, as in 810. For example, the feedback may indicate that the recommended container may not have been available, that the recommended container was not strong enough for shipping heavy or fragile items included in the item package, or that the recommended container may not have been made of a material suitable for shipping fragile or sharp-edged items (e.g., the recommended container may be flexible, rather than stiff, or may be easily punctured.)

While several of the example embodiments illustrated herein are described in terms of a group of items, the techniques described herein may be applied by the system to recommend a container (standard or custom) suitable for shipping a single item to a customer, in other embodiments.

A packaging information system may be further described using the following example. In this example, an e-commerce organization sells items of various types that can be shipped to customers. Five example items are shown in an item parameter data store, in Table 1, below. In this example, the entry for each item includes a corresponding unique identifier, name, and type in columns 1-3. The item parameter data store also includes columns for storing values for various physical parameters of each item (columns 4-6), which in this example includes the item height, length, and width.

TABLE 1

| | | | item | item | item |
|---|---|---|---|---|---|
| | item | item | height | length | width |
| item ID | name | type | (in) | (in) | (in) |
| 4982 | book1 | book | 8.40 | 6.40 | 2.59 |
| 4325 | book2 | book | 8.29 | 6.40 | 2.59 |
| 2309 | plate38 | plate | 0.92 | 9.40 | 9.40 |
| 0873 | shoe17 | shoe | 14.00 | 8.00 | 6.54 |
| 1832 | DVD1 | DVD | 7.48 | 5.31 | 0.55 |

While not shown, in other embodiments, additional information may be stored in an item parameters data store, such as the volume or weight of the item, a confidence level for the item dimension values, information on statistical variances in the dimension values, whether the item has been designated to receive special damage protection, or other indications of allowable deviations from the dimension values. In some embodiments, a manufacturer or supplier may provide item dimensions for the items shown in Table 1. In other embodiments, the item dimension values may be values measured automatically or by agents in the facility, or may be values that have been estimated based on various containers in which the items have been handled. These dimension values may be used to recommend a standard container and/or recommend custom container dimension values for use in forming a custom container in which each item may be packaged, either alone or along with other items in an item package.

In some embodiments, dimension values and/or other parameter values for the standard containers may be stored in one or more tables, databases, or other data structures, such as the container parameters data store illustrated in Table 2 below. In this example, a standard container identifier, a standard container name, and a standard container type are stored in each entry of Table 2 in columns 1-3. Dimension values for various standard containers are shown in columns 4-6. In some embodiments, a manufacturer or supplier of a standard container may provide the values of various standard container parameters, including container dimensions. In other embodiments, standard container parameters may be determined by measuring one or more instances of the standard container.

In this example, the available standard containers include three types of boxes in which items may be shipped and two types of mailing envelopes in which items may be shipped (as shown in rows 4-5 of the data store).

TABLE 2

| container | container | container | height | length | width |
|---|---|---|---|---|---|
| ID | name | type | (inches) | (inches) | (inches) |
| 413 | smallbox1 | box | 19.0 | 13.0 | 11.75 |
| 293 | smallbox2 | box | 22.0 | 18.0 | 11.75 |
| 338 | bigbox1 | box | 24.00 | 16.00 | 16.00 |
| 557 | mailer1 | mailer | 0.25 | 5.00 | 5.00 |
| 806 | mailer2 | mailer | 0.40 | 9.00 | 12.00 |

In the example illustrated by Table 2, the values for the height, length, and width are shown for each standard container. In some embodiments, a manufacturer or supplier may provide the volume along with the dimensions, while in other embodiments, the packaging information system may calculate the volume from supplied or measured dimensions. In some embodiments, additional information regarding various standard containers (e.g., the weight or volume of the standard containers, a strength rating, or an indication of protective packaging materials or filler to be used in preparing items for shipment in the standard containers) may be maintained in a standard container parameters data store. In general, such a data store may include the values of more, fewer, or different parameters than those illustrated in Table 2.

In some embodiments, custom container dimension values and/or other parameter values for the custom container forming devices may be stored in one or more tables, databases, or other data structures, such as the container parameters data store illustrated in Table 3 below. In this example, a custom container forming device identifier and container type that the device is configured to form are stored in each entry of Table 3 in columns 1-2. The corrugate blank widths used with the respective custom container forming devices are identified in column 3.

In this example, the available custom container forming devices receive three different corrugate blanks and are configured to form three types of containers, small boxes, medium sized boxes and large boxes (as shown in column 2 of the data store).

TABLE 3

| | | Corrugate |
|---|---|---|
| Device | Container | blank width |
| ID | type | (inches) |
| 1485 | small | 20 |
| 1485 | medium | 28 |
| 1485 | large | 36 |
| 4329 | small | 10 |
| 4329 | medium | 20 |
| 4329 | large | 30 |

In some embodiments, additional information about various custom container forming devices (e.g., a strength rating of the corrugate used, speed of forming, different shapes of custom containers that can be formed, or an indication of protective packaging materials or filler to be used in preparing items for shipment in the custom containers) may be maintained in a custom container forming device parameters data store. In general, such a data store may include the values of more, fewer, or different parameters than those illustrated in Table 3.

In some embodiments, the packaging information system may store recommended and actual container dimensions (standard or custom) used for item packages in a table, database, or other data structure, such as Table 4 below, and may use this information to analyze various packaging related operations in the materials handling facility. In this example, Table 4 illustrates a package parameters data store, in which each entry (row) includes information about actual versus recommended containers for item packages used for shipping items to customers.

In this example, each entry includes a list of the container contents (e.g., the contents of an item package) along with the number of copies of each item included in the item package, and the identifiers of both the recommended container and the actual container used to package and ship the item package. For example, in Table 4, column 3 is used to store the name of the standard container recommended or the custom container dimension values recommended for a custom container. Column 4 is used to store the name of the actual standard container used to handle each item package or the dimensions actually used to form a custom container. In other embodiments, the dimensions of the standard containers may be used instead of the names. In this example, columns 5-6 may be used to store customer feedback for an item package shipment (e.g., customer ratings for damage and container size, respectively), and column 7 may be used to store agent feedback for the item package shipment (e.g., too small, too large).

In some embodiments, additional information may be stored in a package parameters data store, such as customer concessions, a date or timestamp for each entry or a batch number or other identifier of specific item or item group instances (not shown). In other embodiments, more, fewer or different parameters may be stored in a package parameters data store, or similar information may be stored in other combinations in one or more other tables, databases, or other data structures.

TABLE 4

| package | package | rec. | actual | damage | size | Agent |
|---|---|---|---|---|---|---|
| ID | contents | cont. | cont. | rating | rating | feedback |
| 872093 | plate38 | smallbox2 | mailer2 | poor | fair | too big |
| 832189 | book1 × 3, | 7″ × 6″ × 4″ | 7″ × 6″ × 4″ | excellent | good | good |
| | book2 × 4, | | | | | |
| | book3 × 7 | | | | | |
| 098731 | book2 × 12, | smallbox1 | smallbox2 | excellent | poor | too small |
| | DVD1 × 2 | | | | | |
| 631248 | book1 × 4 | 17″ × 10″ × 8″ | 17″ × 10″ × 8″ | excellent | good | good |
| | book2 × 8 | | | | | |
| | shoe17 × 3 | | | | | |

While several of the examples described above involve item packages that include two or more items, the methods may be applied by the system to recommend a container suitable for handling a single item in the materials handling facility and/or to determine if dimensions stored for the item are inaccurate based on the actual container used to handle the item, in other embodiments.

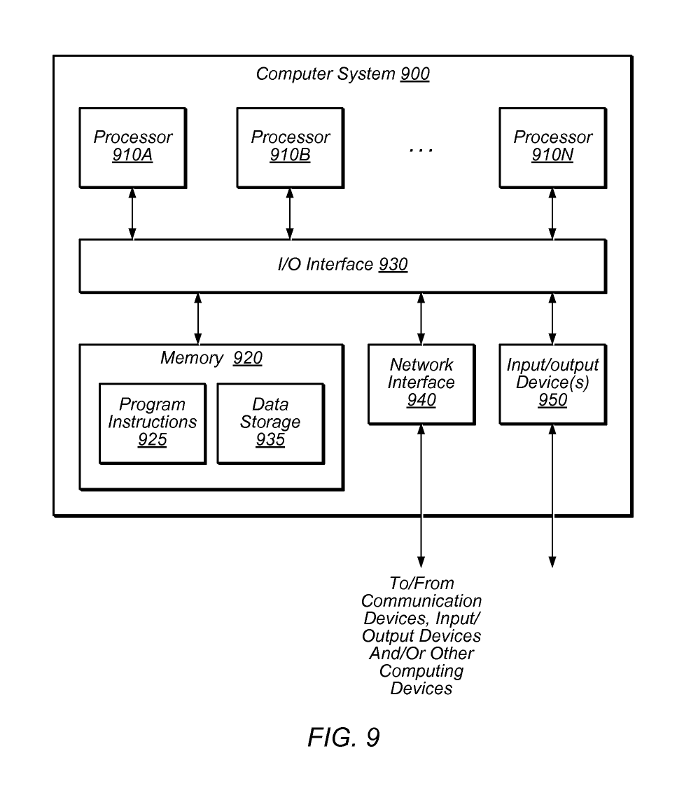

Various operations of a packaging information system, such as those described herein, may be executed on one or more computer systems, interacting with various other devices in a materials handling facility, according to various embodiments. One such computer system is illustrated by the block diagram in FIG. 9. In the illustrated embodiment, a computer system 900 includes one or more processors 910A, 910B through 910N, coupled to a non-transitory computer-readable storage medium 920 via an input/output (I/O) interface 930. The computer system 900 further includes a network interface 940 coupled to an I/O interface 930, and one or more input/output devices 950. In some embodiments, it is contemplated that a packaging information system may be implemented using a single instance of the computer system 900, while in other embodiments, multiple such systems or multiple nodes making up the computer system 900 may be configured to host different portions or instances of a packaging information system. For example, in one embodiment, some data sources or services (e.g., capturing actual container information) may be implemented via one or more nodes of the computer system 900 that are distinct from those nodes implementing other data sources or services (e.g., recommending a container for an item package). In some embodiments, a given node may implement the functionality of more than one component of a packaging information system.

In various embodiments, the computer system 900 may be a uniprocessor system including one processor 910A, or a multiprocessor system including several processors 910A-910N (e.g., two, four, eight, or another suitable number). The processors 910A-910N may be any suitable processor capable of executing instructions. For example, in various embodiments the processors 910A-910N may be general-purpose or embedded processors implementing any of a variety of instruction set architectures (ISAs), such as the x86, PowerPC, SPARC, or MIPS ISAs, or any other suitable ISA. In multiprocessor systems, each of the processors 910A-910N may commonly, but not necessarily, implement the same ISA.

The non-transitory computer-readable storage medium 920 may be configured to store executable instructions and/or data accessible by the one or more processors 910A-910N. In various embodiments, the non-transitory computer-readable storage medium 920 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above, are shown stored within the non-transitory computer-readable storage medium 920 as program instructions 925 and data storage 935, respectively. In other embodiments, program instructions and/or data may be received, sent or stored upon different types of computer-accessible media, such as non-transitory media, or on similar media separate from the non-transitory computer-readable storage medium 920 or the computer system 900. Generally speaking, a non-transitory, computer-readable storage medium may include storage media or memory media such as magnetic or optical media, e.g., disk or CD/DVD-ROM coupled to the computer system 900 via the I/O interface 930. Program instructions and data stored via a non-transitory computer-readable medium may be transmitted by transmission media or signals such as electrical, electromagnetic, or digital signals, which may be conveyed via a communication medium such as a network and/or a wireless link, such as may be implemented via the network interface 940.

In one embodiment, the I/O interface 930 may be configured to coordinate I/O traffic between the processors 910A-910N, the non-transitory computer-readable storage medium 920, and any peripheral devices in the device, including the network interface 940 or other peripheral interfaces, such as input/output devices 950. In some embodiments, the I/O interface 930 may perform any necessary protocol, timing or other data transformations to convert data signals from one component (e.g., non-transitory computer-readable storage medium 920) into a format suitable for use by another component (e.g., processors 910A-910N). In some embodiments, the I/O interface 930 may include support for devices attached through various types of peripheral buses, such as a variant of the Peripheral Component Interconnect (PCI) bus standard or the Universal Serial Bus (USB) standard, for example. In some embodiments, the function of the I/O interface 930 may be split into two or more separate components, such as a north bridge and a south bridge, for example. Also, in some embodiments, some or all of the functionality of the I/O interface 930, such as an interface to the non-transitory computer-readable storage medium 920, may be incorporated directly into the processors 910A-910N.

The network interface 940 may be configured to allow data to be exchanged between the computer system 900 and other devices attached to a network, such as other computer systems, or between nodes of the computer system 900. In various embodiments, the network interface 940 may support communication via wired or wireless general data networks, such as any suitable type of Ethernet network. For example, the network interface 940 may support communication via telecommunications/telephony networks such as analog voice networks or digital fiber communications networks, via storage area networks such as Fibre Channel SANs, or via any other suitable type of network and/or protocol.

Input/output devices 950 may, in some embodiments, include one or more display terminals, keyboards, keypads, touchpads, scanning devices, voice or optical recognition devices, or any other devices suitable for entering or retrieving data by one or more computer systems 900. Multiple input/output devices 950 may be present in the computer system 900 or may be distributed on various nodes of the computer system 900. In some embodiments, similar input/output devices may be separate from the computer system 900 and may interact with one or more nodes of the computer system 900 through a wired or wireless connection, such as over the network interface 940.

As shown in FIG. 9, the memory 920 may include program instructions 925 which may be configured to implement a packaging information system and data storage 935, which may comprise various tables, databases and/or other data structures accessible by the program instructions 925. In one embodiment, the program instructions 925 may include various software modules configured to implement a product dimension estimator, a product dimension correction system, a planning service, a container recommendation service (which may include or make use of a specialty packaging service), a transportation costing service, and/or a package performance analyzer. The data storage 935 may include various data stores for maintaining one or more protected item lists, data representing physical characteristics of items and/or other item parameter values (such as those illustrated as being stored in Table 1), standard container parameter values (such as those illustrated as being stored in Table 2), custom container forming device parameter values (such as those illustrated as being stored in Table 3), item package information (such as those illustrated as being stored in Table 4), shipping reports (not shown), actual or expected shipping costs, avoidable shipping costs, package performance reports, etc. The data storage 935 may also include one or more data stores for maintaining data representing delivery related feedback, such as customer ratings, experiences and the like.

In various embodiments, the parameter values and other data illustrated herein as being included in one or more data stores may be combined with other information not described or may be partitioned differently into more, fewer, or different data structures. In some embodiments, data stores used in a packaging information system, or in components or portions thereof, may be physically located in one memory or may be distributed among two or more memories. These memories may be part of a single computer system or they may be distributed among two or more computer systems, such as two computer systems connected by a wired or wireless local area network, or through the Internet, in different embodiments. Similarly, in other embodiments, different software modules and data stores may make up a packaging information system and/or any of the various components thereof described herein.

Users may interact with the packaging information system (and/or various components thereof) in various ways in different embodiments, such as to automatically measure and/or manually specify measured dimension values for items and/or packaging, to specify and/or modify thresholds to be used when determining suspect item dimensions, or to specify package performance reports to be generated and/or report parameters. For example, some users may have physical access to the computing system 900, and if so, may interact with various input/output devices 950 (e.g., user interface 750) to provide and/or receive information. Alternatively, other users may use client computing systems to access the packaging information system and/or its constituent components, such as remotely via the network interface 940 (e.g., via the Internet and/or the World Wide Web). In addition, some or all of the packaging information system components may provide various feedback or other general types of information to users (e.g., in response to user requests) via one or more input/output devices 950.

Those skilled in the art will appreciate that the computing system 900 is merely illustrative and is not intended to limit the scope of embodiments. In particular, the computing system and devices may include any combination of hardware or software that can perform the indicated functions, including computers, network devices, internet appliances, PDAs, wireless phones, pagers, etc. The computing system 900 may also be connected to other devices that are not illustrated, or instead may operate as a stand-alone system. In addition, the functionality provided by the illustrated components may in some embodiments be combined in fewer components or distributed in additional components. Similarly, in some embodiments the functionality of some of the illustrated components may not be provided and/or other additional functionality may be available.

Those skilled in the art will also appreciate that, while various items are illustrated as being stored in memory or storage while being used, these items or portions of them may be transferred between memory and other storage devices for purposes of memory management and data integrity. Alternatively, in other embodiments, some or all of the software components may execute in memory on another device and communicate with the illustrated computing system via inter-computer communication. Some or all of the system components or data structures may also be stored (e.g., as instructions or structured data) on a non-transitory, computer-accessible medium or a portable article to be read by an appropriate drive, various examples of which are described above. In some embodiments, instructions stored on a computer-accessible medium separate from computer system 900 may be transmitted to computer system 900 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the techniques described herein may be practiced with other computer system configurations.

Those skilled in the art will appreciate that in some embodiments the functionality provided by the methods and systems discussed above may be provided in alternative ways, such as being split among more software modules or routines or consolidated into fewer modules or routines. Similarly, in some embodiments, illustrated methods and systems may provide more or less functionality than is described, such as when other illustrated methods instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments, illustrated data structures may store more or less information than is described, such as when other illustrated data structures instead lack or include such information respectively, or when the amount or types of information that is stored is altered. The various methods and systems as illustrated in the figures and described herein represent example embodiments. The methods and systems may be implemented in software, hardware, or a combination thereof in other embodiments. Similarly, the order of any method may be changed and various elements may be added, reordered, combined, omitted, modified, etc., in other embodiments.

From the foregoing, it will be appreciated that, although specific embodiments have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a computer-readable storage medium, other aspects may likewise be so embodied. Various modifications and changes may be made as would be obvious to a person skilled in the art having the benefit of this disclosure. It is intended to embrace all such modifications and changes and, accordingly, the above description to be regarded in an illustrative rather than a restrictive sense.

What is claimed is:

1. A computer-implemented method of selecting a container for shipping an item, comprising:
under control of one or more computing systems configured with executable instructions,
identifying a materials handling facility with inventory that includes the item;
identifying a standard container available at the materials handling facility for shipping the item, the standard container identified at least in part based upon physical characteristics associated with the item;
determining custom container dimension values for forming at the materials handling facility a custom container for shipping the item, the custom container dimension values dependent at least in part upon the physical characteristics associated with the item;
determining a standard container total fulfillment cost for shipping the item using the identified standard container;
determining a custom container total fulfillment cost for shipping the item using a container having the custom container dimension values;
if the standard container total fulfillment cost is more than the custom container total fulfillment cost:
forming a custom container having a size large enough to contain the item;
selecting the formed custom container for shipping the item; and
if the standard container total fulfillment cost is less than or equal to the custom container total fulfillment cost, selecting the standard container for shipping the item.

2. The computer-implemented method of claim 1, wherein the custom container total fulfillment cost includes a load balancing factor to balance load between:
at least one custom container packing station, each of the at least one custom container packing stations having one or more custom container forming devices; and
at least one standard container packing station.

3. The computer-implemented method of claim 2, wherein an amount of the load balancing factor is variable.

4. The computer-implemented method of claim 1, wherein the custom container total fulfillment cost includes an estimated transportation cost for transporting the item using a container having the custom container dimension values.

5. A non-transitory computer-readable storage medium storing instructions for enabling selection of a container for shipping an item package, the instructions when executed by a processor causing the processor to:
obtain an estimated standard container total fulfillment cost to ship the item package in a standard container;
obtain an estimated custom container total fulfillment cost to ship the item package in a custom container;
select the custom container for shipping the item package if the estimated custom container total fulfillment cost is less than the estimated standard container total fulfillment cost; and
select the standard container for shipping the item package if the estimated standard container total fulfillment cost is less than the estimated custom container total fulfillment cost.

6. The non-transitory computer-readable storage medium of claim 5, the instructions when executed by a processor further causing the processor to:
identify a materials handling facility capable of shipping the item package;
wherein the estimated standard container total fulfillment cost is based at least in part upon an estimated transportation cost to transport the item package from the identified materials handling facility in the standard container; and
wherein estimated custom container total fulfillment cost is based at least in part upon an estimated transportation cost to transport the item package from the identified materials handling facility in the custom container.

7. The non-transitory computer-readable storage medium of claim 5, wherein the estimated custom container total fulfillment cost is based at least in part upon a load balancing factor for balancing load across a plurality of packing stations.

8. The non-transitory computer-readable storage medium of claim 7, wherein the load balancing factor varies based at least in part upon a number of item packages recommended for packaging in a custom container.

9. The non-transitory computer-readable storage medium of claim 7, wherein the load balancing factor varies based at least in part upon a historical load.

10. The non-transitory computer-readable storage medium of claim 7, wherein the load balancing factor varies based at least in part upon an anticipated load.

11. The non-transitory computer-readable storage medium of claim 5, wherein the item package includes a plurality of items.

12. The non-transitory computer-readable storage medium of claim 5, wherein the estimated custom container total fulfillment cost is based at least in part upon a volume of the custom container.

13. The non-transitory computer-readable storage medium of claim 12, wherein the volume of the custom container is determined based at least in part on physical characteristics associated with the item package.

14. The non-transitory computer-readable storage medium of claim 12, wherein the volume of the custom container is determined based at least in part on physical characteristics associated with one or more items included in the item package.

15. The non-transitory computer-readable storage medium of claim 12, wherein the volume of the custom container is determined based at least in part on physical characteristics associated with the item package and a non-item content.

16. A computing system, comprising:
one or more processors; and
a memory coupled to the one or more processors and storing program instructions that when executed by the one or more processors cause the one or more processors to:
receive a request to ship a first item and a second item;
determine at least a first item package and a second item package, each of the first item package and the second item package containing a different combination of the first item and the second item;
identify a first materials handling facility and a second materials handling facility, each of the first materials handling facility and the second materials handling facility capable of shipping at least one of the first item package and the second item package;
for each of the first item package and the second item package,
obtain a container recommendation set for shipping the item package;
if the item package can be shipped from the first materials handling facility,
obtain a standard container transportation cost to ship the item package from the first materials handling facility in a standard container;
obtain a custom container transportation cost to ship the item package from the first materials handling facility in a custom container;
if the item package can be shipped from the second materials handling facility,
obtain an estimated standard container transportation cost to ship the item package from the second materials handling facility;
obtain an estimated custom container transportation cost to ship the item package from the second materials handling facility; and
determine an estimated lowest total fulfillment cost combination to ship the first item and the second item based at least in part on the obtained estimated standard container transportation costs and obtained estimated custom container transportation costs.

17. The computing system of claim 16, wherein the estimated lowest total fulfillment cost combination includes selecting a custom container formed in the first materials handling facility based at least in part on recommend custom container dimension values for use in forming a custom container to ship the first item package from the first materials handling facility.

18. The computing system of claim 17, wherein the first item package includes the first item.

19. The computing system of claim 17, wherein the first item package includes the first item and the second item.

20. The computing system of claim 17, wherein the estimated lowest total fulfillment cost combination includes selecting a standard container to ship the second item package from a second materials handling facility.

21. The computing system of claim 16, wherein the estimated lowest total fulfillment cost combination is further based at least in part upon a load balancing factor added to each of the estimated custom container transportation costs.

22. The computing system of claim 21, wherein the load balancing factor varies over time based at least in part on a current load of at least one of the first materials handling facility and the second materials handling facility.

23. The computing system of claim 16, wherein the estimated lowest total fulfillment cost combination is further based upon:
standard container additional costs added to each obtained estimated standard container transportation cost; and
custom container additional costs added to each obtained estimated custom container transportation cost.

24. The computing system of claim 23, wherein the standard container additional costs include one or more of: a cost of corrugate, a labor cost, an overhead cost, a materials handling cost, and an agent cost.

25. The computing system of claim 23, wherein the custom container additional costs include one or more of: a cost of corrugate, a labor cost, an overhead cost, a handling cost, an agent cost, and a custom container forming device use cost.

26. The computing system of claim 16, wherein the container recommendation set includes:
a recommendation for a standard container for shipping the item package;
recommended custom container dimension values for use in forming a custom container for use in shipping the item package.
